(19) United States
(12) Patent Application Publication
(10) Pub. No.: US 2012/0306720 A1
(43) Pub. Date: Dec. 6, 2012

(54) ANTENNA UNIT AND PANEL ARRAY ANTENNA DEVICE

(75) Inventors: Shinji TAMAI, Kanagawa-ken (JP); Taihei NAKADA, Kanagawa-ken (JP)

(73) Assignee: Kabushiki Kaisha Toshiba, Tokyo (JP)

(21) Appl. No.: 13/415,014

(22) Filed: Mar. 8, 2012

(30) Foreign Application Priority Data
Jun. 6, 2011 (JP) 2011-126738

(51) Int. Cl. H01Q 1/50; H01Q 21/00

(52) U.S. Cl. 343/893; 343/906

(57) ABSTRACT

An antenna unit includes an antenna substrate, a reflective plate, a receiver board, a transmitter board, a cooling plate and a connection interface. The reflective plate is disposed on an antenna element forming surface of the antenna substrate. The receiver board is disposed on a surface of the antenna substrate opposite to a surface facing the reflective plate, and has a receiver module to process a received signal . The transmitter board is disposed substantially parallel to a surface of the receiver board opposite to a surface facing the antenna substrate, and has a transmitter module to process a transmission signal. The cooling plate is disposed on a surface of the transmitter board opposite to the surface facing the receiver board and is configured to cool down heat generated by the transmitter module. The connection interface connects the transmitter board and the receiver board to transmit a signal therebetween.

### CROSS-REFERENCE TO RELATED APPLICATION

This application is based upon and claims the benefit of priority from the prior Japanese Patent Application No. 2011-126738, filed on Jun. 6, 2011, the entire contents of which are incorporated herein by reference.

### FIELD

Embodiments of the present invention relate to a panel array antenna device for measuring an angle and distance of a target and an antenna unit which is used in this panel array antenna device.

### BACKGROUND

A panel array antenna device includes a plurality of antenna units. Each antenna unit includes an antenna substrate on which an antenna element is formed, a transmitter module that performs transmission processing on a signal to be transmitted from the antenna element, and a receiver module that performs reception processing on a signal received by the antenna element.

A conventional antenna unit is of a vertical composite unit type in which an antenna substrate and a transmitter and receiver module are separately configured (see, Japanese Patent Application Publication No. 2006-332840). When a dipole antenna is formed on the antenna substrate, a reflective plate (a reflector) is disposed on the antenna substrate in such a manner as to cover the dipole antenna. The transmitter and receiver module is configured of a single circuit board on which parts respectively performing transmission processing and reception processing are mounted. The transmitter and receiver boards are arranged perpendicularly on one of two surfaces of the antenna substrate opposite to that on which the reflective plate is attached.

According to the requirements specifications of antenna elements, the antenna elements are arranged at certain intervals in a substrate surface direction of the antenna substrate of the panel array antenna device. For this reason, an allowable dimension of the antennal substrate in the board surface direction with respect to the transmitter and receiver board is fixed at a certain level. Thus, in the conventional array unit, the transmitter and receiver board needs to be extended in a direction perpendicular to the antenna substrate. Accordingly, there is a problem that downsizing of the antenna unit and downsizing of the antenna device are inhibited.

### BRIEF DESCRIPTION OF THE DRAWINGS

FIG. 1 shows a configuration of a panel array antenna device according to a first embodiment;

FIG. 2 shows a system diagram of a receiver module which is formed in a receiver board of FIG. 1;

FIG. 3 shows a system diagram of a transmitter module which is formed in a receiver board of FIG. 1;

FIG. 4 shows a configuration of a circulator in FIG. 1;

FIG. 5 shows a system diagram of the panel array antenna device in FIG. 1;

FIG. 6 shows a configuration of a conventional antenna array;

FIG. 7 shows a configuration of an antenna unit according to a second embodiment;

FIG. 8 shows a system diagram of a transmitter module which is formed in a transmitter board of FIG. 7;

FIG. 9 shows a system diagram of a panel array antenna device which is formed by connecting a plurality of antenna units with one another;

FIG. 10 shows a configuration of an antenna unit according to a third embodiment;

FIG. 11 shows a system diagram of a receiver module which is formed in a receiver board of FIG. 10;

FIG. 12 shows a configuration of a circulator in FIG. 10; and

FIG. 13 shows a system diagram of a panel array antenna device formed by connecting a plurality of antenna units in FIG. 10 with each other.

### DETAILED DESCRIPTION

According to the embodiments, an antenna unit comprising: an antenna substrate having an antenna element forming surface in which an antenna element is formed; a reflective plate disposed on the antenna element forming surface of the antenna substrate; a receiver board disposed on a surface of the antenna substrate opposite to a surface facing the reflective plate of the antenna substrate, the receiver board having a receiver module formed therein and configured to process a signal received by the antenna element; a transmitter board disposed substantially parallel to a surface of the receiver board opposite to a surface facing the antenna substrate, the transmitter board having a transmitter module formed therein and configured to transmit a transmission signal from the antenna element of the antenna substrate; a cooling plate disposed on a surface of the transmitter board opposite to a surface facing the receiver board, and configured to cool down heat generated by the transmitter module; and a connection interface connecting the transmitter board and the receiver board and configured to transmit a signal therebetween, wherein the transmission signal generated by the transmitter module is sent to the antenna substrate via the connection interface and the receiver module.

Hereinafter, embodiments of the invention will be described with reference to the drawings.

### First Embodiment

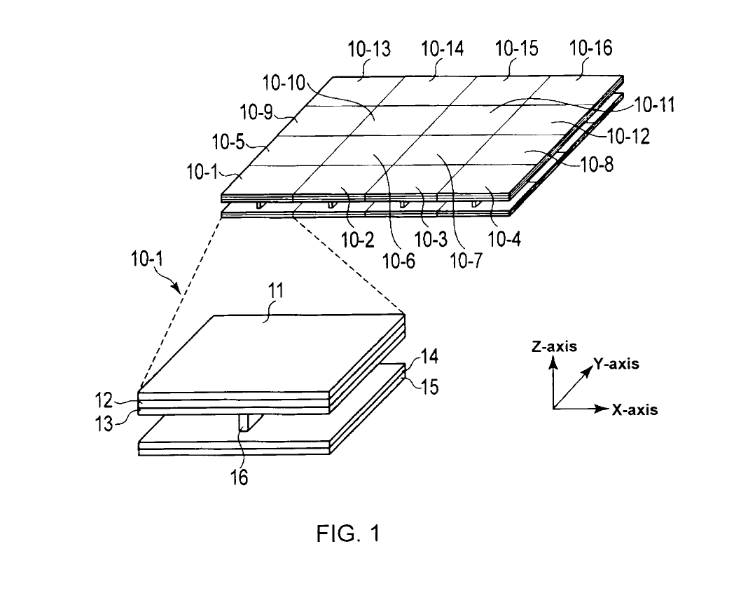

FIG. 1 is a schematic drawing showing a configuration example of a panel array antenna device according to a first embodiment. The panel array antenna device is formed by connecting a plurality of antenna units with each other. In the present embodiment, the panel array antenna device has 16 antenna units 10-1 to 10-16 being arranged in the X-axis and Y-axis directions and connected with each other. While, in the present embodiment, an example where 16 antenna units are arranged is described, but the present invention is not limited to this configuration.

The antenna units 10-1 to 10-16 which form the panel array antenna device will be described. The antenna units 10-1 to 10-16 have similar functions, and thus the antenna unit 10-1 is described below. The antenna unit 10-1 includes a reflective plate 11, an antenna substrate 12, a receiver board 13, a transmitter board 14, a cooling plate 15, and a circulator 16. Note that, a metal plate (a front panel) may be disposed between the antenna substrate 12 and the receiver board 13.

One antenna element is formed in the antenna substrate 12. The antenna element is a patch antenna, for example. A dipole antenna may be used as the antenna element.

The reflective plate 11 is disposed on a surface of the antenna substrate 12 on which the antenna element is formed so as to cover the antenna element 12.

A receiver module 130 to perform reception processing on a signal which is received by the antenna element is formed in the receiver board 13. The receiver board 13 is stacked on one of the surfaces of the antenna substrate 12 that is opposite to the surface on which the reflective plate 11 is disposed.

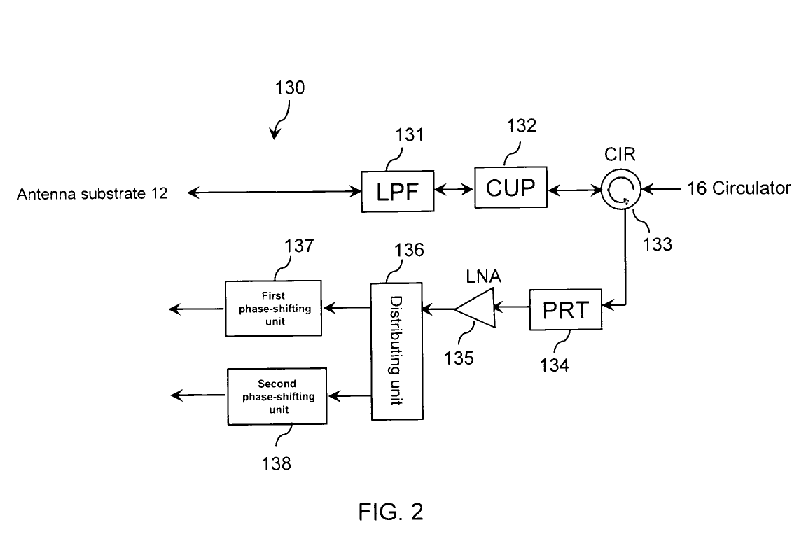

FIG. 2 shows an example of a system diagram of the receiver module 130 according to the first embodiment. The receiver module 130 includes a low-pass filter (LPF) 131, a coupler (CUP) 132, a circulator 133, a protector (PRT) 134, a low noise amplifier (LNA) 135, a distributing unit 136, a first phase-shifting unit 137, and a second phase-shifting unit 138.

A transmission signal which is supplied from the transmitter board 19 via the circulator 16 is outputted to the antenna substrate 12 via the circulator 133, the coupler 132, and the low-pass filter 131. A received signal which is received by the antenna substrate 12 is outputted to the protector 134 via the low-pass filter 131, the coupler 132, and the circulator 133. The protector 134 protects the low noise amplifier 135 so as to prevent a high-power signal from being suddenly inputted to the low noise amplifier 135.

The low noise amplifier 135 amplifies the signal supplied via the protector 134 and outputs the amplified signal to the distributing unit 136. The distributing unit 136 distributes the signal from the low noise amplifier 135 into two, and outputs one to the first phase-shifting unit 137 and the other to the second phase-shifting unit 138.

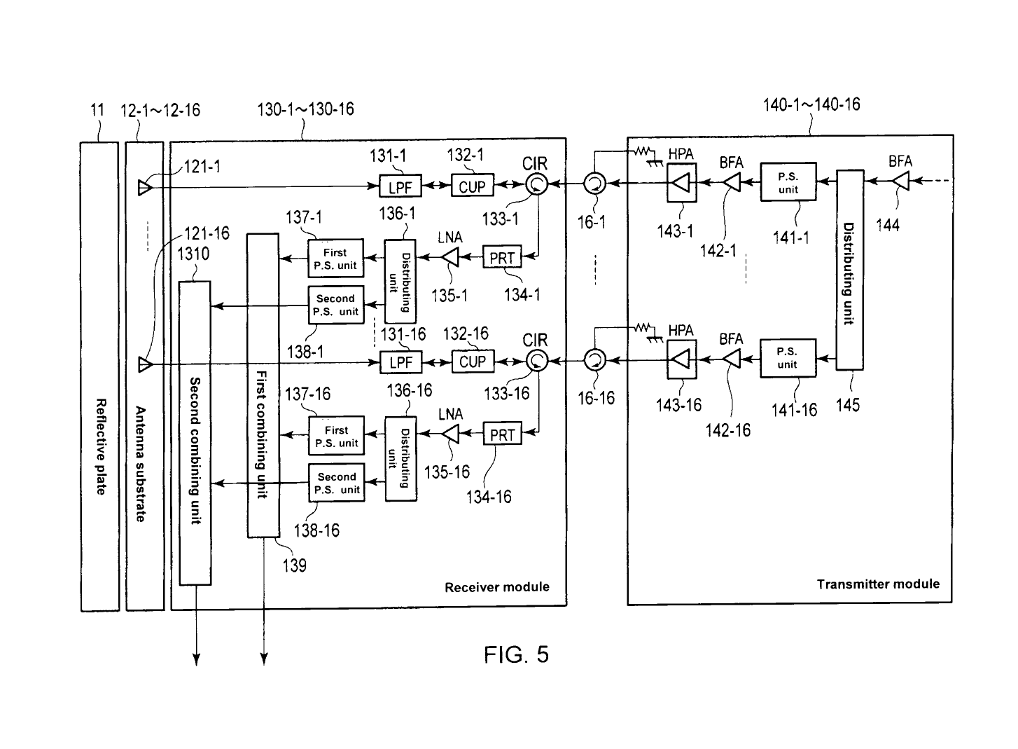

The first phase-shifting unit 137 controls a phase of the signal from the distributing unit 136 and outputs the signal after the phase control to a subsequent stage. As shown in FIG. 5, in a case where the plurality of antenna units are connected with each other, a first combining unit 139 is formed in the subsequent stage of the first phase-shifting unit 137. The first combining unit 139 is, for example, formed in each antenna unit in a tournament manner and combines signals from the first phase-shifting units 137 of the antenna units. The first combining unit 139 combines the signals from the first phase-shifting units 137 of the respective antenna units, thereby creating a ΔEL signal which is a difference signal in a longitudinal direction (an elevation direction, hereinafter referred to as an EL direction) of the antenna substrate 12.

The second phase-shifting unit 138 controls a phase of the signal from the distributing unit 136 and outputs the signal after the phase control to a subsequent stage. As shown in FIG. 5, in a case where the plurality of antenna units are connected with each other, a second combining unit 1310 is formed in the subsequent stage of the second phase-shifting unit 138. The second combining unit 1310 is, for example, formed in each antenna unit in a tournament manner and combines signals from the second phase-shifting units 138 of the antenna units. The second combining unit 1310 combines the signals from the second phase-shifting units 138 of the respective antenna units, thereby creating a Σ signal which is a sum signal and a ΔAZ signal which is a difference signal in a traverse direction (an azimuth direction, hereinafter referred to as an AZ direction) of the antenna substrate 12. Note that, the first and second phase-shifting units 137, 138 mean that there are two receiver systems. Here, the example is described where the first phase-shifting unit 137 creates the ΔEL signal and the second phase-shifting unit 138 creates the ΔAZ signal. However, the first phase-shifting unit 137 can create the ΔAZ signal and the second phase-shifting unit 138 can create the ΔEL signal.

A transmitter module 140 to perform transmission processing is formed in the transmitter board 14. The transmitter board 14 is disposed substantially parallel to a one of the surfaces of the receiver board 13 opposite to the surface stacked on the antenna substrate 12. The transmitter board 14 and the receiver board 13 are connected with each other via the circulator 16.

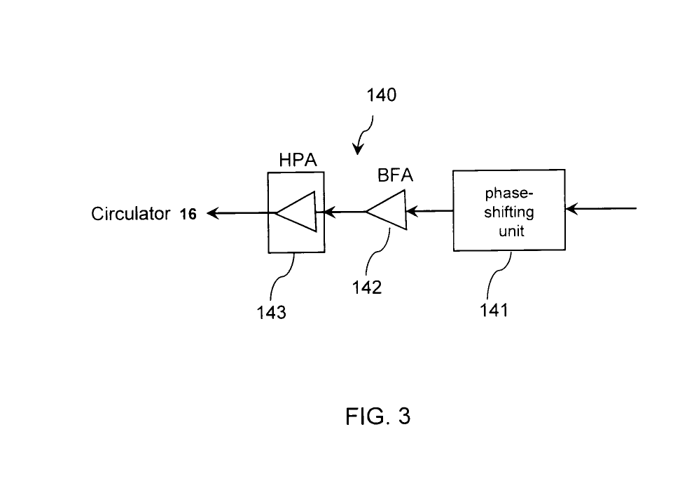

FIG. 3 shows an example of a system diagram of the transmitter module 140 according to the first embodiment. The transmitter module 140 includes a phase-shifting unit 141, a buffer amplifier (BFA) 142, and a high-power amplifier (HPA) 143.

The phase-shifting unit 141 controls a phase of a signal which is supplied to the transmitter module 140. The phase-shifting unit 141 outputs a signal after the phase control to the buffer amplifier 142. The signal outputted from the phase-shifting unit 141 is amplified by the butter amplifier 142 and the high-power amplifier 143 and is outputted to the circulator 16.

As shown in FIG. 5, when the plurality of antenna units are connected to each other, the buffer amplifier 144 and the distributing unit 145 are formed in a preceding stage of the phase-shifting unit 141. The buffer amplifier 144 is formed in any of the antenna units which are connected with each other. The distributing unit 145 is formed in each antenna unit in a tournament manner, for example, and distributes the signal amplified by the buffer amplifier 144 and supplies the signal to the phase-shifting unit 141 of each antenna unit.

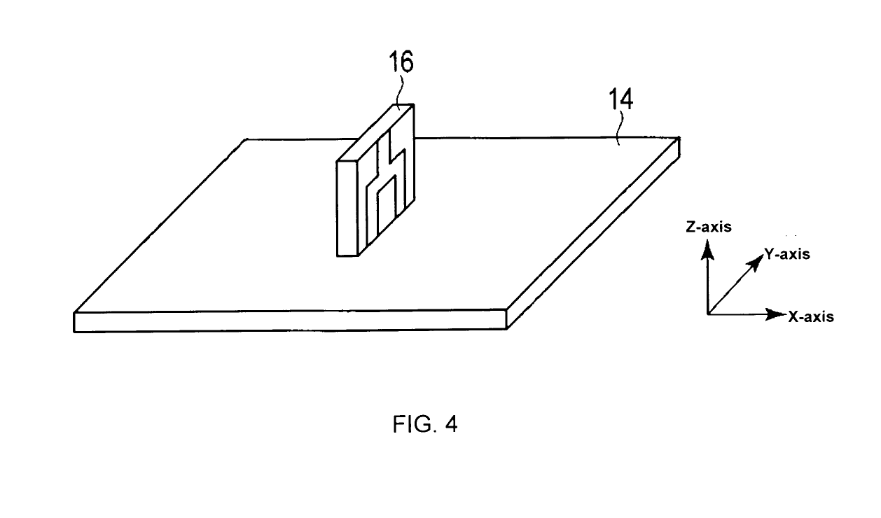

The circulator 16 is a connection interface which is disposed between the receiver board 13 and the transmitter board 14. The circulator 16 connects the receiver board 13 and the transmitter board 14. FIG. 4 is a schematic diagram showing a configuration of the circulator 16 in the antenna unit 10-1 according to the first embodiment. The circulator 16 is a component with a width of 20 mm, a depth of 20 mm, and a height of 5 mm, for example. As shown in FIG. 4, the circulator 16 is disposed in such a manner that a board surface on which lines are formed is substantially perpendicular to the receiver board 13 and the transmitter board 14. The circulator includes three terminals respectively connected with the circulator 133 of the receiver module 130, the high-power amplifier 143 of the transmitter module 140, and a ground of the transmitter module 140. The circulator 16 guides the transmission signal which is outputted from the transmitter board 14 to the receiver substrate 13 and blocks the transmission of the signal which is received by the antenna element to the transmitter board 14.

The cooling plate 15 is stacked on one of surfaces of the transmitter board 14 opposite to the surface to be connected with the receiver board 13. The cooling plate 15 cools the heat generated by the transmitter module 140. Note that the cooling plate 15 may be entirely provided on the transmitter board 14 or may be partially provided on the transmitter board 14. In the transmitter module 140, the high-power amplifier 143 needs to be cooled. For this reason, the cooling plate 15 may be provided only on the rear surface of a portion on which the high-power amplifier 143 is formed.

FIG. 5 shows an example of a system diagram of the panel array antenna device shown in FIG. 1. In FIG. 5, the signal amplified by the buffer amplifier 144 is distributed by the distributing unit 145 and is supplied to the phase-shifting units 141-1 to 141-16. The signal which is subjected to the phase control performed by the phase-shifting units 141-1 to 141-16 is amplified by the buffer amplifiers 142-1 to 142-16 and the high-power amplifiers 143-1 to 143-16, and the transmission signal is outputted to the circulators 16-1 to 16-16.

The transmission signals outputted from the transmitter modules 140-1 to 140-16 are outputted to the receiver modules 130-1 to 130-16 via the circulators 16-1 to 16-16, respectively.

In the receiver modules 130-1 to 130-16, the transmission signals are transmitted to the antenna elements 121-1 to 121-16 which are respectively formed in the antenna substrates 12-1 to 12-16, via the circulators 133-1 to 133-16, the couplers 132-1 to 132-16, and the low-pass filters 131-1 to 131-16, and the transmission signals are transmitted from the antenna elements 121-1 to 121-16.

In the receiver modules 130-1 to 130-16, the received signals which are received by the antenna elements 121-1 to 121-16 are supplied to the low noise amplifiers 135-1 to 135-16 via the low-pass filters 131-1 to 131-16, the couplers 132-1 to 132-16, the circulators 133-1 to 133-16, and the protectors 134-1 to 134-16. The received signals are amplified by the low noise amplifiers 135-1 to 135-16 and distributed into two systems by the distributing units 136-1 to 136-16. The distributed received signals are subjected to the phase control performed by the first phase-shifting units 137-1 to 137-16 and the second phase-shifting units 138-1 to 138-16 and are outputted to the first combining unit 139 and the second combining unit 1310.

The first combining unit 139 combines the signals which are supplied from the first phase-shifting units 137-1 to 137-16, and creates the ΔEL signal of the antenna substrates 12-1 to 12-16. The second combining unit 1310 combines the signals which are supplied from the second phase-shifting units 138-1 to 138-16 to create the Σ signal and the ΔAZ signal of the antenna substrates 12-1 to 12-16.

As described above, in the first embodiment, the receiver module 130 and the transmitter module 140 are respectively formed in the receiver board 13 and the transmitter board 14. In addition, the receiver board 13 is stacked on the antenna substrate 12 and the transmitter board 14 is disposed substantially parallel to the receiver board 13.

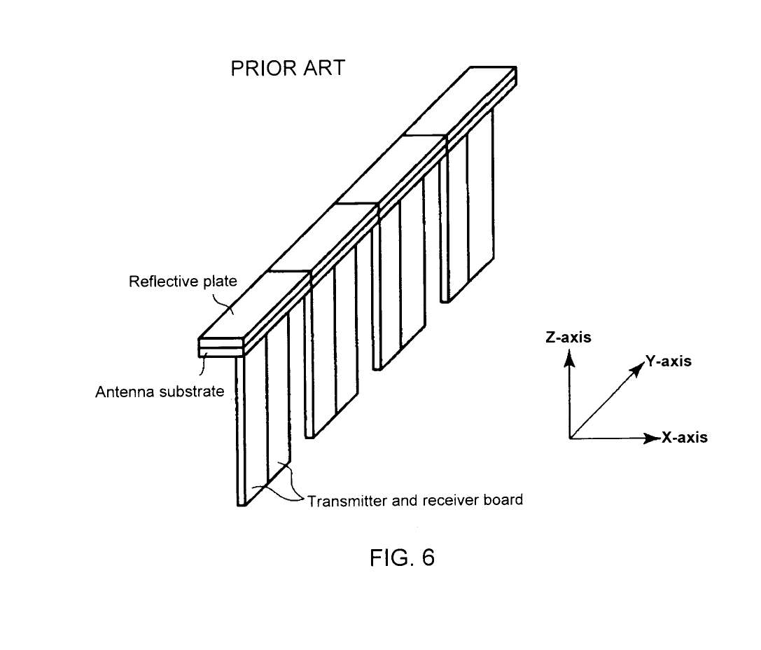

In a conventional antenna unit as shown in FIG. 6, a transmitter board and a receiver board are formed on a same circuit board. In this case, the transmitter and receiver boards have a size restriction in the Y-axis direction, and thus are required to have a certain length in the Z-axis direction.

In contrast, in the antenna unit 10 according to the first embodiment, the transmitter module 140 and the receiver module 130 are completely separately configured. The receiver board 13 is stacked on the antenna board 12 and the transmitter board 14 is disposed substantially parallel to the receiver board 13. With this configuration, the size of the antenna unit 10 in the Z-axis direction can be reduced, and thus the antenna unit 10 can be downsized.

Moreover, in the conventional antenna unit shown in FIG. 6, the transmitter and receiver module performs transmission processing and reception processing on a single board. In general, in a transmission processing unit including a power system, parts are more likely to fail than in a reception processing unit. In the conventional configuration, even when only a part required for transmission processing breaks down, the entire transmitter and receiver board has to be replaced.

In contrast, in the antenna unit 10 according to the first embodiment, the transmitter module 140 and the receiver module 130 are completely separately configured. Thus, when the transmitter module 140 breaks down, only the transmitter module 140 needs to be replaced. In other words, the antenna unit 10 according to the first embodiment has an advantageous effect even from a viewpoint of easier maintenance.

Accordingly, the antenna unit according to the first embodiment and the panel array antenna device including this antenna unit can be downsized without deteriorating its performance.

In addition, in the first embodiment, the transmitter module 140 has no circulator, and the circulator 16 connects the receiver board 13 and the transmitter board 14. With this configuration, a space in the transmitter board 14 on which a circulator is originally designed to be formed can be used for another usage. Thus, the transmitter board 14 can be more effectively utilized.

### Second Embodiment

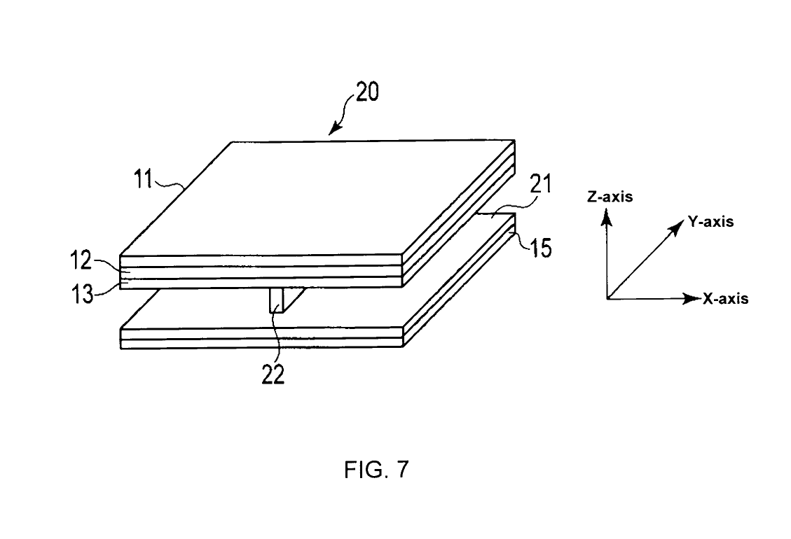

FIG. 7 is a schematic view showing an example of a configuration of an antenna unit 20 according to a second embodiment. The antenna unit 20 includes a reflective plate 11, an antenna substrate 12, a receiver board 13, a transmitter board 21, a cooling plate 15, and a connector 22.

A transmitter module 210 to perform transmission processing is formed in the transmitter board 21. The transmitter board 21 is disposed substantially parallel to one of the surfaces of the receiver board 13 opposite to a surface to be stacked on the antenna substrate 12. The transmitter board 21 and the receiver board 13 are connected with each other via the connector 22.

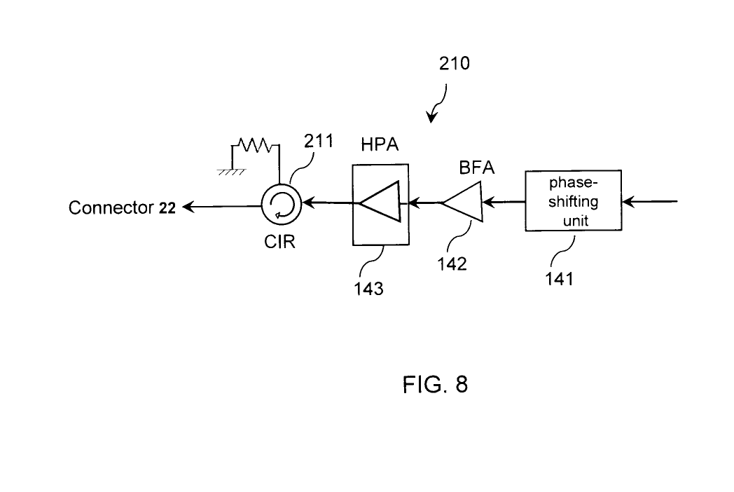

FIG. 8 shows an example of a system diagram of the transmitter module 210 according to the second embodiment. The transmitter module 210 includes a phase-shifting unit 141, a buffer amplifier 142, a high-power amplifier 143, and a circulator 211. The phase-shifting unit 141 controls a phase of a signal which is supplied to the transmitter module 210. The phase-shifting unit 141 outputs the signal after the phase control to the buffer amplifier 142. The signal outputted from the phase-shifting unit 141 is amplified by the buffer amplifier 142 and the high-power amplifier 143 and the amplified output signal is outputted to the connector 22 via the circulator 211.

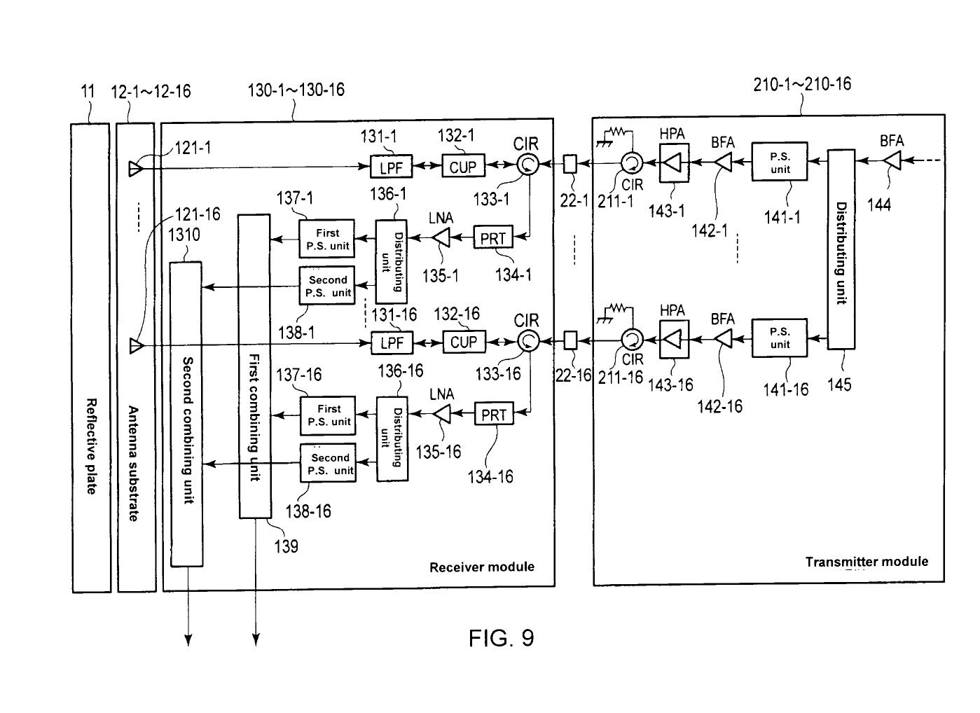

Also, in a case where a plurality of antenna units are connected with each other to form a panel array antenna device, as shown in FIG. 9, the buffer amplifier 144 and a distributing unit 145 are formed in a preceding stage of the phase-shifting unit 141. The buffer amplifier 144 is formed in any one of the antenna units being connected with each other. The distributing unit 145 is formed in each antenna unit in a tournament manner, for example, and distributes the signal amplified by the buffer amplifier 144 and supplies the signal to the phase-shifting unit 141 of each antenna unit.

The connector 22 is used as a connection interface between the receiver board 13 and the transmitter board 21. The connector 22 is, for example, an SMA connector.

FIG. 9 shows an example of a system diagram of the panel array antenna device which is formed by connecting the plurality of antenna units 20 shown in FIG. 7 with each other. In FIG. 9, the signal amplified by the buffer amplifier 144 is distributed by the distributing unit 145 and supplied to the phase-shifting units 141-1 to 141-16. The signals which are subjected to the phase control performed by the phase-shifting units 141-1 to 141-16 are amplified by the buffer amplifiers 142-1 to 142-16 and the high-power amplifiers 143-1 to 143-16, and the output signals are outputted via the circulators 211-1 to 211-16.

The transmission signals outputted from the transmitter modules 210-1 to 210-16 are outputted to the receiver modules 130-1 to 130-16 via the connectors 22-1 to 22-16.

As described above, in the second embodiment, the receiver module 130 and the transmitter module 210 are respectively formed in the receiver board 13 and the transmitter board 21. Moreover, the receiver board 13 is stacked on the antenna substrate 12 and the transmitter board 21 is disposed substantially parallel to the receiver board 13. With this configuration, a space of the antenna unit 20 in the Z-axis direction can be reduced. In other words, the antenna unit 20 can be downsized.

In addition, in the antenna unit 20 according to the second embodiment, the transmitter module 210 and the receiver module 130 are completely separately configured. Thus, when the transmitter module 210 breaks down, only the transmitter module 210 needs to be replaced. In other words, the antenna unit 20 according to the second embodiment has an advantageous effect even from a viewpoint of easier maintenance.

Accordingly, the antenna unit according to the second embodiment and the panel array antenna device including this antenna unit can be downsized without deteriorating its performance.

### Third Embodiment

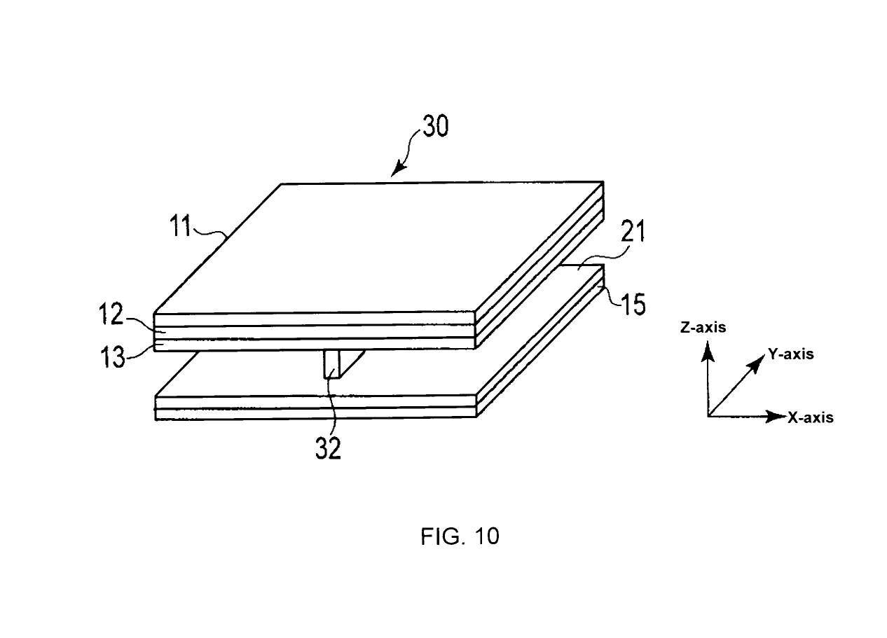

FIG. 10 is a schematic view showing an example of a configuration of an antenna unit 30 according to a third embodiment. The antenna unit 30 shown in FIG. 10 includes a reflective plate 11, an antenna substrate 12, a receiver board 31, a transmitter board 21, a cooling plate 15, and a circulator 32.

A receiver module 310 to perform reception processing is formed in the receiver board 31. The receiver board 31 is stacked on one of the surfaces of the antenna substrate 12 opposite to a surface on which the reflective plate 11 is mounted.

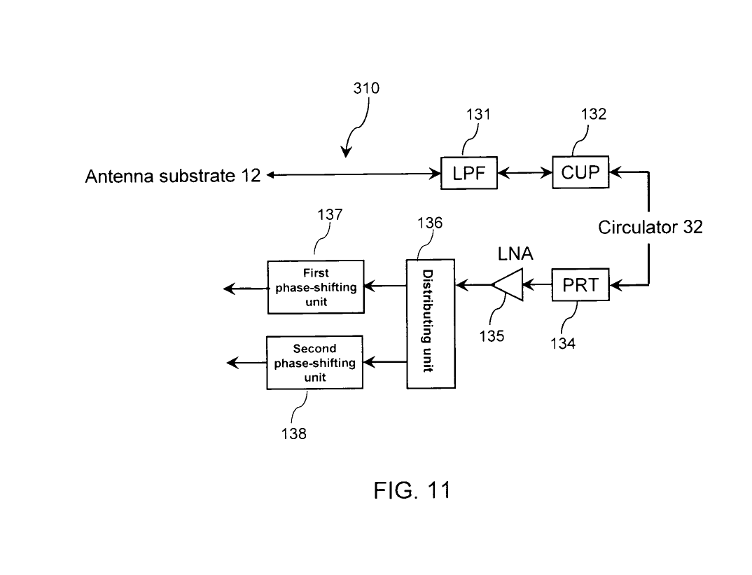

FIG. 11 shows an example of a system diagram of the receiver module 310 according to the third embodiment. The receiver module 310 includes a low-pass filter 131, a coupler 132, a protector 134, a low noise amplifier 135, a distributing unit 136, a first phase-shifting unit 137, and a second phase-shifting unit 138.

The transmission signal which is supplied from the circulator 32 is outputted to the antenna substrate 12 via the coupler 132 and the low-pass filter 131. Also the received signal which is received by the antenna substrate 12 is outputted to the protector 134 via the low-pass filter 131, the coupler 132, and the circulator 32.

The circulator 32 is a connection interface which is disposed between the receiver board 31 and the transmitter board 21.

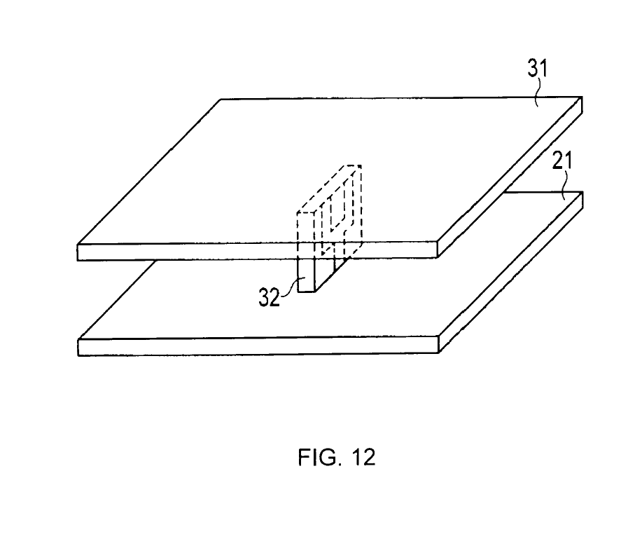

The circulator 32 connects the receiver board 31 and the transmitter board 21. FIG. 12 is a schematic diagram showing a configuration of the circulator 32 in an antenna unit 30 according to the third embodiment. The circulator 32 is a component with a width of 20 mm, a depth of 20 mm, and a height of 5 mm, for example. As shown in FIG. 12, the circulator 32 is disposed in such a manner that a board surface on which lines are formed is connected substantially perpendicular to the receiver board 31 and the transmitter board 21. The circulator 32 has three terminals and the terminals are respectively connected with the coupler 132 of the receiver module 310, the protector 134 of the receiver module 310, and a circulator 211 of the transmitter module 210. The circulator 32 guides the transmission signal which is outputted from the transmitter board 21 to the receiver board 31 and returns the signal which is received by the antenna element to the receiver board 31.

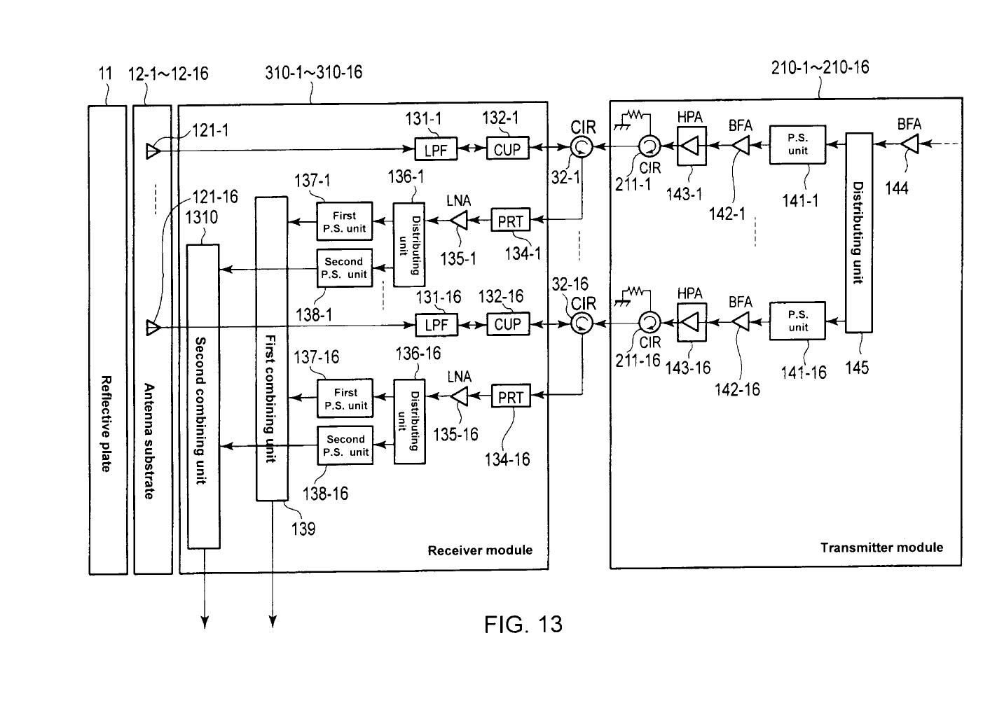

FIG. 13 shows an example of a system diagram of the panel array antenna device which is formed by connecting the plurality of antenna units with each other. In FIG. 13, the transmitter modules 210-1 to 210-16 output transmission signals to the circulators 32-1 to 32-16. The receiver modules 310-1 to 310-16 receive the transmission signals via the circulators 32-1 to 32-16.

The receiver modules 310-1 to 310-16 transmit the transmission signals through the antenna elements 121-1 to 121-16 via the couplers 132-1 to 132-16 and the low-pass filters 121-1 to 121-16.

In the receiver modules 310-1 to 310-16, the received signals which are received by the antenna elements 121-1 to 121-16 are supplied to the low noise amplifiers 135-1 to 135-16 via the low-pass filters 131-1 to 131-16, the couplers 132-1 to 132-16, the circulators 32-1 to 32-16, and the protectors 134-1 to 134-16. The received signals are amplified by the low noise amplifiers 135-1 to 135-16 and distributed into two systems by the distributing units 136-1 to 136-16. The distributed received signals are subjected to the phase control performed by the first phase-shifting units 137-1 to 137-16 and the second phase-shifting units 138-1 to 138-16 and are outputted to the first combining unit 139 and the second combining unit 1310.

As described above, in the third embodiment, the receiver module 310 and the transmitter module 210 are respectively formed in the receiver board 31 and the transmitter board 21. Moreover, the receiver board 31 is stacked on the antenna substrate 12 and the transmitter substrate 21 is disposed substantially parallel to the receiver board 31. With this configuration, a space of the antenna unit 30 in the Z-axis direction can be reduced. In other words, the antenna unit 30 can be downsized.

In the antenna unit 30 according to the third embodiment, the transmitter module 210 and the receiver module 310 are completely separately configured. Thus, when the transmitter module 210 breaks down, only the transmitter module 210 needs to be replaced. In other words, the antenna unit 30 according to the third embodiment has an advantageous effect even from a viewpoint of easier maintenance.

Accordingly, the antenna unit according to the third embodiment and the panel array antenna device including this antenna unit can be downsized without deteriorating its performance.

In addition, in the third embodiment, the receiver module 310 has no circulator, and the circulator 32 formed on the spacer substrate connects the receiver board 31 and the transmitter board 21. With this configuration, a space in the receiver board 31 on which a circulator is originally designed to be formed can be used for another usage. Thus, the receiver board 31 can be more effectively utilized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna unit comprising:
an antenna substrate having an antenna element forming surface in which an antenna element is formed;
a reflective plate disposed on the antenna element forming surface of the antenna substrate;
a receiver board disposed on a surface of the antenna substrate opposite to a surface facing the reflective plate of the antenna substrate, the receiver board having a receiver module formed therein and configured to process a signal received by the antenna element;
a transmitter board disposed substantially parallel to a surface of the receiver board opposite to a surface facing the antenna substrate, the transmitter board having a transmitter module formed therein and configured to transmit a transmission signal from the antenna element of the antenna substrate;
a cooling plate disposed on a surface of the transmitter board opposite to a surface facing the receiver board, and configured to cool down heat generated by the transmitter module; and
a connection interface connecting the transmitter board and the receiver board and configured to transmit a signal therebetween, wherein
the transmission signal generated by the transmitter module is sent to the antenna substrate via the connection interface and the receiver module.

2. The antenna unit according to claim 1, wherein the connection interface is a circulator which is disposed between the receiver board and the transmitter board and which is configured to guide a transmission signal outputted from the transmitter board to the receiver board and block a transmission of a signal received by the antenna element to the transmitter board.

3. The antenna unit according to claim 1, wherein the connection interface is a circulator which is disposed between the receiver board and the transmitter board and which is configured to guide a transmission signal outputted from the transmitter board to the receiver board and return a signal received by the antenna element to the receiver board.

4. The antenna unit according to claim 1, wherein the connection interface is a connector.

5. A panel array antenna device comprising a plurality of antenna units, each antenna unit including:
an antenna substrate having an antenna element forming surface in which an antenna element is formed;
a reflective plate disposed on the antenna element forming surface of the antenna substrate;
a receiver board disposed on a surface of the antenna substrate opposite to a surface facing the reflective plate of the antenna substrate, the receiver board having a receiver module formed therein and configured to process a signal received by the antenna element;
a transmitter board disposed substantially parallel to a surface of the receiver board opposite to a surface facing the antenna substrate, the transmitter board having a transmitter module formed therein and configured to transmit a transmission signal from the antenna element of the antenna substrate;
a cooling plate disposed on a surface of the transmitter board opposite to a surface facing the receiver board, and configured to cool down heat generated by the transmitter module; and
a connection interface connecting the transmitter board and the receiver board and configured to transmit a signal therebetween, wherein
the plurality of receiver modules combines signals to be supplied to the respective receiver modules and the plurality of transmitter modules distributes signals to be supplied to the respective transmitter modules.
